(19) United States
(12) Patent Application Publication
(10) Pub. No.: US 2016/0285244 A1
(43) Pub. Date: Sep. 29, 2016

(54) ELECTRONIC COMPONENT UNIT AND ELECTRIC CONNECTION BOX

(71) Applicant: YAZAKI CORPORATION, Tokyo (JP)

(72) Inventor: Yukihiro Kawamura, Shizuoka (JP)

(21) Appl. No.: 15/080,320

(22) Filed: Mar. 24, 2016

(30) Foreign Application Priority Data
Mar. 27, 2015 (JP) 2015-066356

(51) Int. Cl. H02B 1/20; B60R 16/03; H02B 1/48

(52) U.S. Cl. CPC H02B 1/20; H02B 1/48; B60R 16/03

(57) ABSTRACT

An electric connection box includes an electronic component unit and a housing into which the electronic component unit is mounted. The electronic component unit includes a bus bar plate that includes a metallic bus bar incorporated in a resin member and electronic components that are electrically connected to the bus bar and are mounted on the bus bar plate. The electronic components include a relay mounted on one surface of the bus bar plate and a resistor mounted on another surface that is the back side of the one surface of the bus bar plate. The resistor is arranged at a position overlapping with the relay in a thickness direction of the bus bar plate.

### CROSS-REFERENCE TO RELATED APPLICATION(S)

The present application claims priority to and incorporates by reference the entire contents of Japanese Patent Application No. 2015-066356 filed in Japan on Mar. 27, 2015.

### BACKGROUND OF THE INVENTION

1. Field of the Invention

The present invention relates to an electronic component unit and an electric connection box.

2. Description of the Related Art

An electric connection box that distributes electric power from a power supply such as a battery to electronic devices is mounted on a vehicle such as an automobile. As the electric connection box of this kind, an electric connection box including an electronic component unit that mounts electronic components such as a relay on a bus bar plate that includes metallic bus bars incorporated in a resin member and a housing that accommodates therein the electronic component unit is disclosed.

An electronic component unit disclosed in WO 2014/030627 is desired to achieve further miniaturization of the electric connection box.

### SUMMARY OF THE INVENTION

The present invention has been made in view of the above circumstances, and an object thereof is to provide an electric component unit and an electric connection box that can achieve further miniaturization.

To achieve the above-described objective, an electronic component unit according to one aspect of the present invention includes a bus bar plate that includes a metallic bus bar incorporated in a resin member; and electronic components that are electrically connected to the bus bar and are mounted on the bus bar plate, wherein the electronic components include a first electronic component that is mounted on one surface of the bus bar plate, and a second electronic component that is mounted on another surface that is a back side of the one surface of the bus bar plate and is arranged at a position overlapping with the first electronic component in a thickness direction of the bus bar plate.

According to another aspect of the present invention, in the electronic component unit, it is preferable that a terminal of at least one of the first electronic component and the second electronic component is connected to a press contact blade that is part of the bus bar and protruding from a surface of the bus bar plate.

According to still another aspect of the present invention, an electric connection box includes an electronic component unit including a bus bar plate that includes a metallic bus bar incorporated in a resin member and electronic components that are electrically connected to the bus bar and are mounted on the bus bar plate; and a housing into which the electronic component unit is mounted, wherein the electronic components includes a first electronic component that is mounted on one surface of the bus bar plate, and a second electronic component that is mounted on another surface that is a back side of the one surface of the bus bar plate and is arranged at a position overlapping with the first electronic component in a thickness direction of the bus bar plate.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view of a schematic configuration of an electric connection box to which an electronic component unit according to an embodiment is applied;

FIG. 2 is a perspective view of a schematic configuration of the electric connection box to which the electronic component unit according to the embodiment is applied;

FIG. 3 is a sectional view of the electric connection box to which the electronic component unit according to the embodiment is applied;

FIG. 4 is a perspective view of a schematic configuration of bus bars of the electronic component unit according to the embodiment;

FIG. 5 is an exploded perspective view of a schematic configuration of an electronic component unit according to a modification of the embodiment;

FIG. 6 is a perspective view of a schematic configuration of the electronic component unit according to the modification of the embodiment; and

FIG. 7 is an exploded perspective view of a schematic configuration of an electric connection box to which the electronic component unit according to the modification of the embodiment is applied.

### DETAILED DESCRIPTION OF THE PREFERRED EMBODIMENTS

The following describes an embodiment according to the present invention in detail based on the drawings. This embodiment does not limit this invention. Components in the following embodiment include ones that can be replaced by those skilled in the art and are easy or substantially the same ones.

### Embodiment

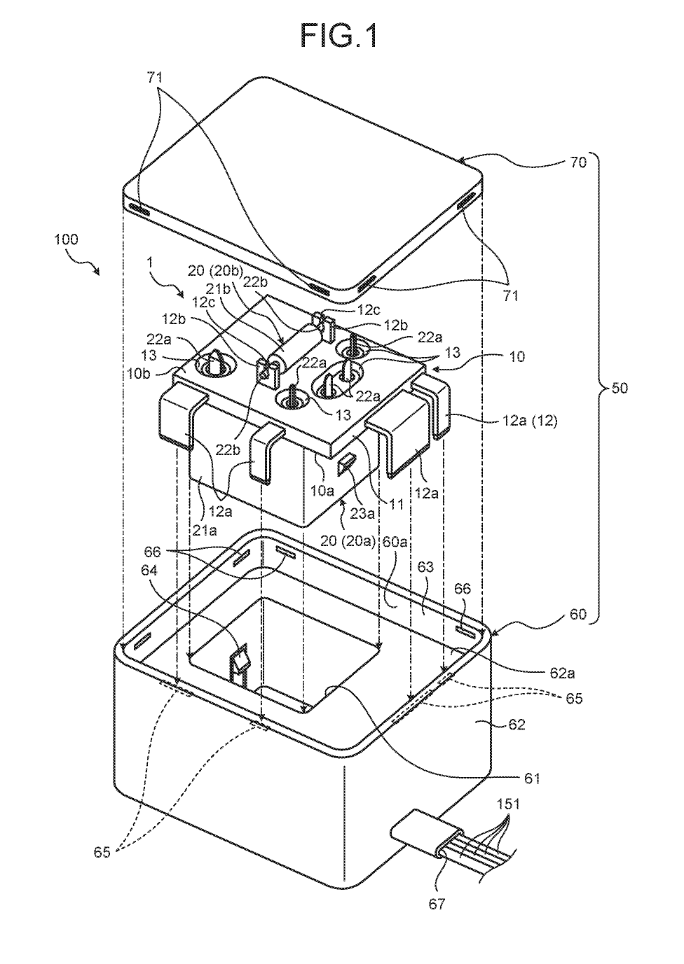

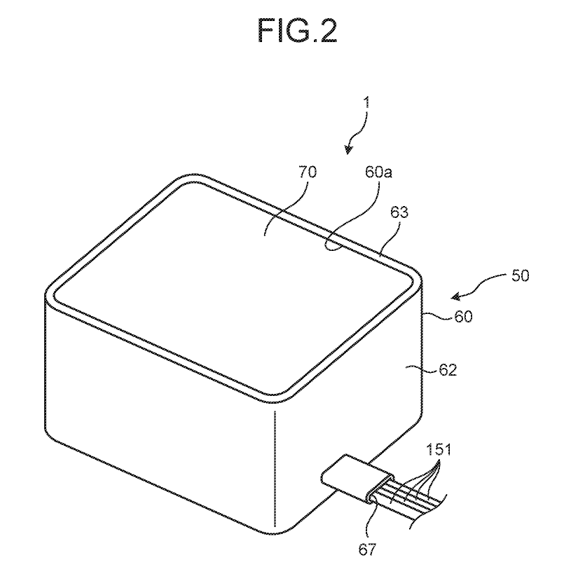

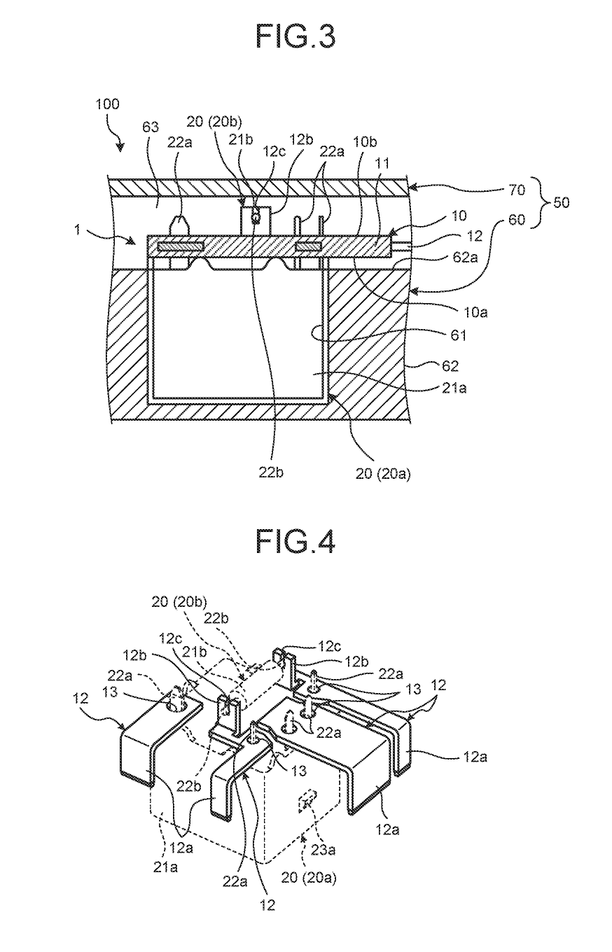

FIG. 1 is an exploded perspective view of a schematic configuration of an electric connection box to which an electronic component unit according to an embodiment is applied. FIG. 2 is a perspective view of a schematic configuration of the electric connection box to which the electronic component unit according to the embodiment is applied. FIG. 3 is a sectional view of the electric connection box to which the electronic component unit according to the embodiment is applied. FIG. 4 is a perspective view of a schematic configuration of bus bars of the electronic component unit according to the embodiment. In FIG. 4, electronic components are indicated by dotted lines.

As illustrated in FIG. 1, this electronic component unit 1 according to the present embodiment constitutes an electronic component module attachably and detachably mounted on an electric connection box 100 mounted on a vehicle such as an automobile. The electric connection box 100 accommodates therein at least one electronic component unit 1, is incorporated into a wire harness (not illustrated) routed in the automobile, and collectively accommodates therein electric parts such as terminal metals, relays, and resistors that constitutes connection processing parts such as electric wires 151. The electric connection box 100 is connected to between a power supply such as a battery and various kinds of electronic devices mounted within the vehicle. The electric connection box 100 distributes electric power supplied from the power supply such as a battery to the various kinds of electronic devices within the vehicle. Although the electric connection box 100 may also be called a junction box, a fuse box, a relay box, or the like, they are collectively called an electric connection box in the present embodiment.

The electric connection box 100 exemplified in FIG. 1 includes the electronic component unit 1 and a housing 50 that mounts the electronic component unit 1 therewithin. The electronic component unit 1 is mounted within the housing 50 of the electric connection box 100 and constitutes part of an electric power distribution circuit that distributes the electric power supplied from the power supply to the various kinds of electronic devices within the vehicle. As illustrated in FIG. 1 and FIG. 3, the electronic component unit 1 includes a bus bar plate 10 and electronic components 20 mounted on the bus bar plate 10.

The electronic components 20 are mounted on the bus bar plate 10 and are elements that exhibit various kinds of functions in this example. Respective terminals of the electronic components 20 are electrically connected to certain bus bars 12 of the bus bar plate 10 and are fixed to the bus bars 12 by soldering or the like. As the electronic components 20 of the present embodiment, a relay 20 (that corresponds to a first electronic component and is denoted by the symbol 20a hereinafter) and a resistor 20 (that corresponds to a second electronic component and is denoted by the symbol 20b hereinafter) are used. In other words, the electronic component unit 1 of the present embodiment is a relay unit module including the relay 20a and the resistor 20b.

As illustrated in FIG. 1 and FIG. 3, the relay 20a includes a main body 21a that is formed in a quadrangular prismatic shape in appearance and incorporates a coil and the like thereinto and a plurality of terminals 22a protruding from one outer face of the main body 21a. The terminals 22a are arranged in parallel with each other. As illustrated in FIG. 1, the resistor 20b includes a main body 21b having a cylindrical appearance and a pair of terminals 22b protruding in opposite directions from both ends of the main body 21b in the axial direction.

The bus bar plate 10 includes a plurality of conductive has bars 12 incorporated in a resin member 11, and in other words, the bus bars 12 are covered with the insulating resin member 11 to be isolated from each other. The bus bar plate 10 is formed by insert molding that injects insulating resin around the bus bars 12 that are formed of conductive metal and are arranged within a mold to integrate the metal and the resin, for example.

The bus bars 12 are formed of the conductive metal and are formed in a substantially plate shape and are bent by press working, for example. As illustrated in FIG, 4, the bus bars 12 are formed with a plurality of terminals 12a for connecting to counterpart terminal metals (not illustrated) attached to terminals of the electric wires 151 when the electronic component unit 1 is mounted on the housing 50 and a plurality of press contact blades 12b for connecting to the resistor 20b by bending.

The terminals 12a are formed in a substantially plate shape and connect to the counterpart terminal metals attached to the terminals of the electric wires 151. The press contact blades 12b are formed in a substantially plate shape having slits 12c at the center in the width direction. Terminals 22b of the resistor 20b are press-fit into the slits 12c, whereby inner edges of the slits 12c are in contact with the terminals 22b, and the press contact blades 12b connect to the terminals 22b of the resistor 20b in a press contact manner.

The bus bars 12 are inserted into a mold for insert molding. The bus bar plate 10 is formed by injecting the insulating resin around the bus bars 12 inserted into the mold and integrally molding (insert molding) each bus bars 12 and the resin member 11. The bus bar plate 10 is formed in a rectangular plate shape as a whole.

As illustrated in FIG. 1, in the bus bar plate 10 in which the bus bars 12 are insert-molded into the resin member 11, the terminals 12a of the respective bus bars 12 protrude from outer edges of the resin member 11 and bend from the outer edges of the resin member 11 of the bus bar plate 10 toward one surface 10a. In the present embodiment, two terminals 12a are arranged on each of the two outer edges on the near side of FIG. 1 among the four outer edges of the resin member 11. The terminals 12a are erected substantially perpendicularly to the one surface 10a of the bus bar plate 10.

The press contact blades 12b protrude from the central part of another surface 10b that is the back side of the one surface 10a of the bus bar plate 10. In the present embodiment, two press contact blades 12b are arranged at the central part of the resin member 11. The press contact blades 12b are erected substantially perpendicularly to another surface 10b of the bus bar plate 10. The terminal 12a and the press contact blade 12b are part of the bus bar 12.

The bus bar plate 10 is formed with through holes 13. The through holes 13 pass through the resin member 11 and the bus bars 12. The through holes 13 cause the terminals 22a of the relay 20a to pass through thereinside, and the terminals 22a are soldered to the bus bars 12.

In the electronic component unit 1 of the present embodiment, the relay 20a is mounted on the one surface 10a of the bus bar plate 10 and the resistor 20b is mounted on another surface 10b that is the back side of the one surface 10a of the bus bar plate 10. The electronic component unit 1 arranges the resistor 20b at a position overlapping with the relay 20a in a thickness direction of the bus bar plate 10. In the present embodiment, the resistor 20b is smaller than the relay 20a, and the entire resistor 20b is arranged at a position overlapping with the relay 20a in the thickness direction in a plan view of the bus bar plate 10. In the present invention, however, part of the resistor 20b may be arranged at a position overlapping with part of the relay 20a in the thickness direction of the bus bar plate 10. To sum up, in the present invention, the resistor 20b being arranged at a position overlapping with the relay 20a in the thickness direction of the bus bar plate 10 refers to the fact that at least part of the resistor 20b is arranged at a position overlapping with at least part of the relay 20a in the thickness direction of the bus bar plate 10.

The housing 50 mounts the electronic component unit 1 therewithin. The housing 50 includes a box 60 and a lid 70 that blocks an opening 60a of this box 60 and is constituted by fitting them together as illustrated in FIG. 1 and FIG. 2, for example. The box 60 and the lid 70 are formed of insulating synthetic resin.

The box 60 is a main member having a accommodating space 61 on which the electronic component unit 1 is mounted. The box 60 includes a box-shaped box main body 62 in which the accommodating space 61 is open to a surface 62a and a frame-shaped part 63 erected on an outer rim of the surface 62a of the box main body 62. The inside of the frame-shaped part 63 is the opening 60a of the box 60. The accommodating space 61 is a recess provided in the surface 62a of the box main body 62 and accommodates therein the relay 20a of the electronic component unit 1. Engaging arms 64 that engage with protrusions 23a provided on the main body 21a of the relay 20a to fix the relay 20a to the box 60 are provided on inner face of the accommodating space 61.

Terminal accommodating parts 65 that accommodates therein the terminal metals attached to the terminals of the electric wires 151 are provided around the accommodating space 61 of the box main body 62. The terminal accommodating parts 65 is open to the surface 62a of the box main body 62 and allow the terminals 12a of the electronic component unit 1 to be inserted therein and the terminals and the terminal metals which are attached to the terminals of the electric wires 151 to be connected to each other An opening 67 for passing the electric wires 151 therethrough is provided in the box main body 62 of the box 60.

The lid 70 is a lid-shaped member that blocks the opening 60a inside the frame-shaped part 63 of the box 60. As illustrated in FIG. 3, when being mounted on the box 60, the lid 70 faces the surface 62a of the box main body 62 with spacing therebetween. The spacing between the lid 70 and the surface 62a of the box main body 62 is formed larger than a protrusion amount of the press contact blades 12b of the bus bar plate 10 from another surface 10b. As illustrated in FIG. 3, the lid 70 accommodates the resistor 20b between the lid 70 and the surface 62a of the box main body 62. The spacing between the lid 70 and the surface 62a of the box main body 62 is equal to spacing of an electric connection box that accommodates therein a conventional electronic component unit in which the press contact blades 12b do not protrude from another surface 10b.

In the housing 50, the lid 70 is mounted on the box 60 so as to block the opening 60a inside the frame-shaped part 63 of the box 60. In the housing 50, locking protrusions 71 provided on outer edges of the lid 70 lock into locking holes 66 provided on inner faces of the frame-shaped part 63 of the box 60, thereby locking the lid 70, for example. Although a direction in which the box 60 and lid 70 are stacked is generally along the vertical direction with this electric connection box 100 fixed to the vehicle, the box 60 and the lid 70 may be installed with the stacking direction having a certain angle relative to the vertical direction depending on the installation condition of the electric connection box 100.

The electronic component unit 1 having the configuration described above is assembled as follows, for example. First, the bus bar plate 10 is placed with the one surface 10a facing upward and with the one surface 10a Parallel to the horizontal direction. The terminals 22a of the relay 20a are passed through the through holes 13, and the main body 21a of the relay 20a is placed on the one surface 10a. The terminals 22a of the relay 20a are fixed to the bus bars 12 and the like on another surface 10b side by reflow soldering or the like. The terminals 22b of the resistor 20b are connected to the press contact blades 12b erected on another surface 10b, whereby the resistor 20b is fixed to the bus bar plate 10. The electronic component unit 1 is thus assembled.

The relay 20a is brought close to the surface 62a of the box main body 62 in the longitudinal direction of the terminals 12a, the relay 20a is accommodated in the accommodating space 61, the terminals 12a are passed through the terminal accommodating parts 65, whereby the thus assembled electronic component unit 1 is mounted on the box main body 62 of the box 60. In this situation, the engaging arms 64 engage with the protrusions 23a. The lid 70 is mounted on the box 60 so as to block the opening 60a inside the frame-shaped part 63 of the box 60, whereby the electronic component unit 1 is mounted on the electric connection box 100.

The electronic component unit 1 described above mounts the relay 20a on the one surface 10a of the bus bar plate 10 and mounts the resistor 20b on another surface 10b thereof. The electronic component unit 1 arranges the entire resistor 20b at a position overlapping with the relay 20a in the thickness direction of the bus bar plate 10. With these configurations, the electronic component unit 1 causes the relay 20a and the resistor 20b to overlap with each other across the bus bar plate 10 and reduces an area required for mounting in a plan view of the bus bar plate 10 compared with a case in which the relay 20a and the resistor 20b are mounted on the same plane of the bus bar plate 10. Consequently, the electronic component unit 1 produces an effect of making it possible to increase the mounting density of the electronic components 20 such as the relay 20a and the resistor 20b and thereby to achieve further miniaturization.

The electronic component unit 1 connects the terminals 22b of the resistor 20b to the press contact blades 12b protruding from another surface 10b of the bus bar plate 10. Consequently, the electronic component unit 1 can fix the resistor 20b to another surface 10b without performing reflow soldering after fixing the relay 20a to the one surface 10a of the bus bar plate 10 by reflow soldering or the like. With this configuration, the electronic component unit 1 prevents the relay 20a mounted on the one surface 10a from separating from the bus bar plate 10 when mounting the resistor 20b on another surface 10b. Consequently, the electronic component unit 1 can surely mount the electronic components 20a and 20b both on the one surface 10a and another surface 10b, respectively, of the bus bar plate 10.

The electric connection box 100 described above, including the electronic component unit 1, produces an effect of making it possible to increase the mounting density of the electronic components 20 such as the relay 20a and the resistor 20b and to achieve further miniaturization.

Modification

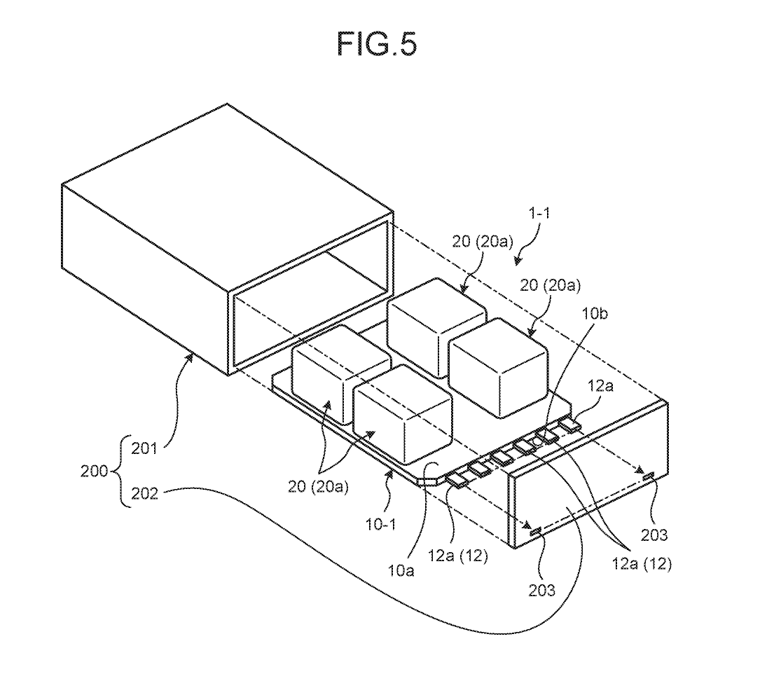

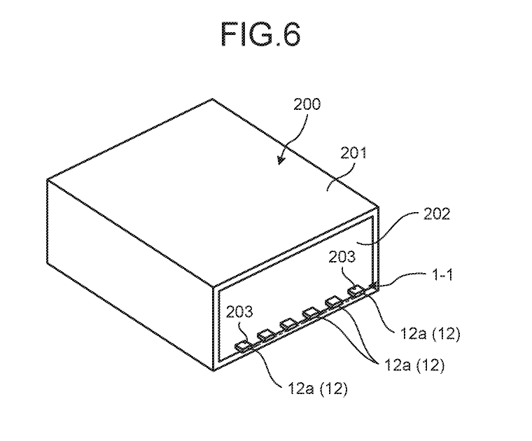

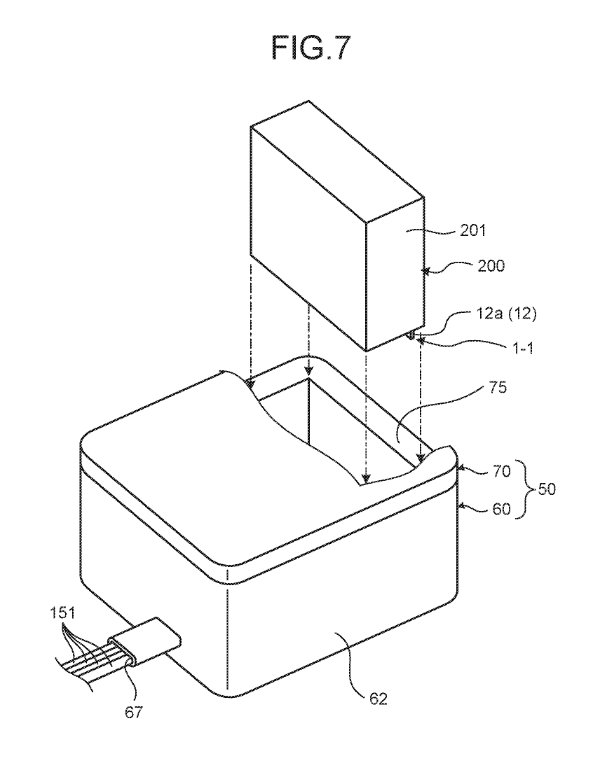

Next, the following describes an electronic component unit according to a modification of the embodiment in detail based on the drawings. FIG. 5 is an exploded perspective view of a schematic configuration of the electronic component unit according to the modification of the embodiment. FIG. 6 is a perspective view of a schematic configuration of the electronic component unit according to the modification of the embodiment. FIG. 7 is an exploded perspective view of a schematic configuration of an electric connection box to which the electronic component unit according to the modification of the embodiment is applied. In FIG. 5 through FIG. 7, the same parts as those of the embodiment are attached with the same symbols, and descriptions thereof are omitted.

As illustrated in FIG. 5, this electronic component unit 1-1 according to the modification of the embodiment is a relay unit module in which a plurality of relays 20a and resistors 20b (not illustrated) are mounted on one bus bar plate 10-1. In the present modification, the electronic component unit 1-1 includes four relays 20a as first electronic components and four resistors 20b as second electronic components, in which they correspond to each other one-to-one, and the corresponding ones are arranged on overlapping positions of the bus bar plate 10-1. In the present embodiment, the relays 20a as the, first electronic components are mounted on the one surface 10a of the bus bar plate 10-1, and the resistors 20b as the second electronic components are mounted on another surface 10b thereof. Although also in the present embodiment the terminals 22b of the resistor 20b are connected to the press contact blades 12b, the present invention may fix the terminals 22b of the resistor 20b to the bus bars 12 by reflow soldering similarly to the terminals 22a of the relay 20a. In the present embodiment, the terminals 12a of the bus bars 12 protrude from a short side of the resin member 11 of the bus bar plate 10-1 in parallel with the surface 10a of the bus bar plate 10-1.

Furthermore, after being accommodated in a case 200 illustrated in FIG. 5 and FIG. 6, the electronic component unit 1-1 is mounted on the housing 50 illustrated in FIG. 7 and is accommodated in the electric connection box 100. As illustrated in FIG. 5 and FIG. 6, the case 200 includes a tubular case main body 201 the far side of which in the drawing is blocked and a lid 202 that accommodates the electronic component unit 1-1 between the lid 202 and, the case main body 201. The case main body 201 accommodates therein the electronic component unit 1-1 with the terminals 12a protruding from an opening. The lid 202 exposes the terminals 12a to the outside of the case 200 through passing holes 203 and is mounted on the case main body 201 so as to block the opening. As illustrated in FIG. 7, the electronic component unit 1-1 is accommodated in the box 60 and is mounted on the housing 50 while being accommodated in the case 200. When the electronic component unit 1-1 is mounted on the housing 50, the terminals 12a of the respective bus bars 12 of the electronic component unit 1-1 connect to connectors (not illustrated) provided in the housing 50 and electrically connect to the electric wires 151.

Also in the modification, the electronic component unit 1-1 produces an effect of making it possible to increase the mounting density of the electronic components 20 such as the relay 20a and the resistor 20b and thereby to achieve further miniaturization similarly to the embodiment. Furthermore, the electronic component unit 1-1 mounts a plurality of the electronic components 20 such as the relays 20a and the resistors 20b on one bus bar plate 10-1 and produces an effect of making it possible to further increase the mounting density of the electronic components 20 and to achieve further miniaturization.

The electronic component unit 1 according to the embodiment of the present invention is not limited to the embodiment, and, various modifications can be made within the scope described in what is claimed.

Although the electronic component unit 1 described above mounts the relay 20a and the resistor 20b as the electronic component, other electronic components such as diodes other than the relay 20a and the resistor 20b may be mounted. Although the electronic component unit 1 described above connects the terminals 22b of the resistor 20b as the second electronic component to the press contact blades 12b, the terminals 22a of the relay 20a as the first electronic component may be connected to the press contact blades 12b in addition to the terminals 22b of the resistor 20b as the second electronic component in the present invention. To sum up, the present invention may provide press contact blades protruding from at least either the one surface 10a or another surface 10b and connect terminals of at least either the first electronic component or the second electronic component to the press contact blades 12b of the bus bars 12.

The electronic component unit according to the present invention mounts the first electronic component on the one surface of the bus bar plate and mounts the second electronic component on another surface thereof. The electronic component unit arranges the second electronic component at a position overlapping with the first electronic component. With these configurations, the electronic component unit causes the first electronic component and the second electronic component to overlap with each other across the bus bar plate and reduces an area required for mounting the electronic components on the bus bar plate in a plan view compared with a case in which the first electronic component and the second electronic component are mounted on the same plane of the bus bar plate. Consequently, the electronic component unit produces an effect of making it possible to increase the mounting density of the electronic components and thereby to achieve further miniaturization.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electronic component unit comprising:
a bus bar plate that includes a metallic bus bar incorporated in a resin member; and
electronic components that are electrically connected to the bus bar and are mounted on the bus bar plate,
wherein
the electronic components include
a first electronic component that is mounted on one surface of the bus bar plate, and
a second electronic component that is mounted on another surface that is a back side of the one surface of the bus bar plate and is arranged at a position overlapping with the first electronic component in a thickness direction of the bus bar plate.

2. The electronic component unit according to claim 1, wherein
a terminal of at least one of the first electronic component and the second electronic component is connected to a press contact blade that is part of the bus bar and protruding from a surface of the bus bar plate.

3. An electric connection box comprising:
an electronic component unit including a bus bar plate that includes a metallic bus bar incorporated in a resin member and electronic components that are electrically connected to the bus bar and are mounted on the bus bar plate; and
a housing into which the electronic component unit is mounted, wherein
the electronic components includes
a first electronic component that is mounted on one surface of the bus bar plate, and
a second electronic component that is mounted on another surface that is a back side of the one surface of the bus bar plate and is arranged at a position overlapping with the first electronic component in a thickness direction of the bus bar plate.
